(19) United States
(12) Patent Application Publication
(10) Pub. No.: US 2005/0040087 A1
(43) Pub. Date: Feb. 24, 2005

(54) Reduced-waste reverse osmosis water supply system

(76) Inventor: Paul Jacuzzi, Winnipeg (CA)

Correspondence Address: ADE & COMPANY, 1700-360 MAIN STREET, WINNIPEG, MB, R3C3Z3, CA

(21) Appl. No.: 10/643,150

(22) Filed: Aug. 19, 2003

(51) Int. Cl. B01D 63/00

(52) U.S. Cl. 210/109; 210/121; 210/257.2; 210/321.65

(57) ABSTRACT

A low-waste or no-waste reverse osmosis water supply system includes a pressurized permeate storage tank connected to the permeate outlet of one or more membrane elements with a valve operable by a user for tapping water on demand from the permeate storage tank. A pressurized waste storage tank is connected to the waste outlet of the element. The waste water from the waste storage, instead of being wasted is supplied on demand to a toilet tank for supplying flush water to a toilet. The operation of the system to supply product and waste is controlled by a pressure detection switch responsive to the filling of the waste tank so that if the system operates with the product tank full all water is fed to waste. The system is controlled by operating a pump which draws waste water away from the waste side at a sufficient rate, substantially independent of the pressure in the waste tank, to prevent accumulation of contaminants on the waste side. A bypass is provided to supply water from the inlet to the toilet tank if temporarily insufficient is available from the system.

This invention relates to system for supplying household water using reverse osmomsis purification while reducing or eliminating waste.

### BACKGROUND OF THE INVENTION

Home reverse osmosis systems for the production of pure drinking water are in common use in households across North America and other developed regions worldwide. They are all very similar in nature and design, incorporating the following features:
a) A saddle valve clamped to the cold water line to feed household water to the water treatment unit through polyethylene tubing.
b) Pre-filtration cartridges to pre-treat the incoming feed water.
   These usually include sediment filtration and a granular activated carbon cartridge to reduce or eliminate chlorine from the municipal water source. Thin film composite membranes have a very low tolerance for chlorine.
c) A spiral-wound, semi-permeable membrane enclosed in a membrane housing through which feed water passes under line pressure. Some of the water will cross the membrane film and be collected as purified product water (permeate); the balance will flow through the membrane element to waste. Most home systems operate with a waste to product ratio of 4:1 ranging to 10:1, depending on the quality of the feed water. This ratio is used to calculate the permeate “recovery rate” of the system that is expressed as a percentage (percentage of permeate recovered to total water used).

Product water is collected in a pressure tank. The tank employs an internal bladder that separates the water from an air pre-charge, usually at about 8 psi. As the tank fills, the pre-charged air is displaced by the incoming water and results in rising air pressure within the product tank. A four-way shut-off valve, connected to the tube connecting the tank to the membrane housing, is activated when the tank is full, as indicated by a backpressure of approximately 35 psi. This valve shuts off the incoming water supply to the RO system (also connected to the four-way valve) and further system operation ceases.

When permeate is drawn from the product tank, usually through a toggle faucet located at a kitchen sink, the pressure drop in the tank allows the shut-off valve to reopen and the system to resume operation until the tank is refilled. The system is operated automatically, depending on whether the permeate tank is filled. Water that passes through the membrane element that is rejected by the thin film is routed by tubing to a saddle mounted on the plumbing system's drainpipe. The waste is discharged into the drainpipe at atmospheric pressure.

In order to keep costs low, residential RO systems employ a “single pass” system design as described above. This simple design does not attempt to recycle the waste stream or introduce it to a second membrane element. Commercial and municipal systems normally employ more sophisticated system designs to recycle the waste stream past another set of membranes or into a “concentrate loop” that is used to feed the membrane element. These enhanced system designs may, under various circumstances, allow the recovery rate to range from 40% to 70%. This is in stark contrast to residential systems that operate with recovery rates ranging from 8% to 20%.

A typical household will use between 6 and 12 litres of product water daily. This water consumption will cause the RO system to produce between 24 and 120 liters of wastewater daily. Annually, waste production can range from 8,700 liters to a theoretical high of 44,000 liters. In some applications this wasted water is not a problem; for example, a system being fed from a lake and returning waste to the lake will not present an issue. Similarly, a non-metered municipal supply used as to feed an RO will not present the operator with any additional costs if large amounts of water are wasted. These situations are the exception however, becoming more infrequent as water conservation initiatives and treated water shortages become commonplace worldwide.

Increasingly, residential RO systems are faced with situations that make their application uneconomic, impractical or undesirable. Large regions of the US southwest and US southeast are commonly faced with water shortages and water use restrictions brought on by drought and overuse. Some municipalities and counties have bylaws in place restricting the use of home RO systems to eliminate this source of waste. Many septic systems in rural homes are unable to absorb the large amounts of RO wastewater produced and become flooded or waterlogged.

Escalating costs of municipal water delivered to residences in many regions of the USA and Canada make RO waste uneconomic. RO wastewater costs to the homeowner may run as high as $C300 per year, or more.

There have been few commercial attempts to design residential RO systems that eliminate or reduce the waste produced. Cross flow filtration systems will always create waste; this is fundamental to their design. The challenge has been to reduce waste production to the minimum and then find a way to recycle the waste produced and use it to offset the use of fresh water elsewhere in the plumbing system.

These products have attempted to re-inject the waste stream into the plumbing system of the home using a booster pump to increase the waste stream pressure to something greater than the municipal line pressure. Problems arise with this strategy:

This design assumes that the waste will be drawn off and used elsewhere in the plumbing system. While some domestic uses for wastewater are benign (irrigation, toilet use) others uses including drinking water, food preparation, bathing and washing clothes may be inappropriate for wastewater.

Booster pumps to allow the waste stream to overcome line pressure will elevate the plumbing systems to higher-than-average levels, potentially causing damage to plumbing system components and appliances.

A major assumption with this design is that water is being used at other points of the plumbing system concurrent to the RO system operating and producing waste. If this concurrent use does not occur, waste will be “looped” within the plumbing system and fed back to the RO intake. This looping of waste concentrate will quickly lead to deteriorating quality of product water (elevated TDS levels) and a shortened membrane element life.

Attempts have been made to recycle waste to a reservoir of fresh water. This kind of system would exist in an RV or boat that carries its own source of fresh water for domestic consumption in a fixed reservoir. The RO system will draw feed water from the fresh water tank and return the waste stream to the tank, effectively creating a concentrate loop, however, using the reservoir to dilute the concentrate. This approach has limited application:

It cannot be used for any application other than a closed loop water system.

The reservoir will see a gradually increasing TDS concentration as the RO system operates and consumes water in the loop. As the quality of the reservoir water deteriorates, the quality of the permeate will deteriorate as well. The reservoir must be topped up continually and routinely purged to assure a somewhat stable quality of product water.

### SUMMARY OF THE INVENTION

It is one object of the invention to provide an improved reverse osmosis water supply apparatus in which the amount of waste is reduced or eliminated by effective use of the waste.

According to one aspect of the invention there is provided a reverse osmosis water supply apparatus comprising:
an inlet for connection to a water source;
at least one reverse osmosis element including a membrane contained in a membrane housing, the element being arranged to receive water from the inlet and having a permeate outlet connected to a product side of the membrane and a waste outlet connected to a waste side of the membrane;
a pressurized permeate storage tank connected to the permeate outlet;
a valve operable by a user for tapping water on demand from the permeate storage tank;
a pressurized waste storage tank connected to the waste outlet;
a flow control device operable to cause flow of water from the source over the membrane for controlling the production from the membrane of the permeate and the waste and operable to halt flow;
a toilet tank for supplying flush water to a toilet;
a filling valve operable to fill the toilet tank to a required level in response to use of the flush water;
a connection from the waste storage tank to the filling valve of the toilet tank for filling the toilet tank with waste from the reverse osmosis element.

Preferably there is provided a control switch for operating the flow control device, the control switch being responsive to a reduction in pressure within the waste storage tank below a predetermined minimum, indicating a requirement for re-filling the waste storage tank, to operate the flow control device to cause said flow.

In this arrangement the control switch, the reverse osmosis element and the flow control device are preferably arranged such that, when the permeate storage tank is filled to less than capacity, the permeate is supplied to and stored in the permeate storage tank and, when the permeate supply tank is filled to capacity, no permeate passes through the membrane and all water received from the inlet is supplied to waste.

The operation status of the RO system is determined by the fill status of the waste tank, not the product tank. The system will operate depending on the demand of water to operate the toilets connected; as the number of toilets increases the system run time will also increase. The demand for toilet refill water will not exceed supply, should the waste tank become emptied, the bypass will take over.

The system uses wastewater exclusively for the use of refilling toilets. It eliminates the concern with using RO wastewater for other personal uses such as bathing or brushing teeth.

In one convenient arrangement which improves product quality, the flow control device comprises a pump having a suction side connected to the waste outlet of the reverse osmosis element and a pressure outlet connected to the pressurized waste storage tank and arranged to draw water is away from the waste side of the membrane at a rate sufficient to ensure adequate flow on the waste side of the membrane to avoid an increase in contamination of the permeate.

In this arrangement, the pump is preferably arranged such that the rate of flow on the waste side is substantially independent of the pressure in the waste storage tank.

In this arrangement, there is preferably provided a flow restrictor between the inlet of the pump and the waste outlet of the element so as to provide a back pressure against the waste side of the membrane.

Another feature provides a bypass duct connected from the inlet directly to the outlet of the waste storage tank for supplying water from the source to the outlet of the waste storage tank, the bypass duct including a pressure regulator valve arranged to operate to allow passage of water from the source to the outlet of the waste storage tank only in the event that the pressure at the outlet of the waste storage tank drops below a predetermined minimum pressure.

In this arrangement, there is preferably provided a back check valve between the duct and the outlet of the waste storage tank to prevent filling of the waste storage tank from the source.

In order to provide a high level of permeate production relative to waste so as to maintain sufficient product to supply needs, preferably there is provided a first and a second reverse osmosis element each including a membrane contained in a membrane housing, the element being arranged to receive water from the inlet and having a permeate outlet connected to a product side of the membrane and a waste outlet connected to a waste side of the membrane and wherein the permeate from the product side of the first is supplied as input to the second.

According to a second aspect of the invention there is provided a reverse osmosis water supply apparatus comprising:
an inlet for connection to a water source;
at least one reverse osmosis element including a membrane contained in a membrane housing, the element being arranged to receive water from the inlet and having a permeate outlet connected to a product side of the membrane and a waste outlet connected to a waste side of the membrane;
a pressurized permeate storage tank;
a valve operable by a user for tapping water on demand from the permeate storage tank;
a pressurized waste storage tank;
an outlet for connection from the waste storage tank to an end use location for use of the waste from the reverse osmosis element;
a flow control device operable to cause flow of water from the source over the membrane for controlling the production from the membrane of the permeate and the waste and operable to halt flow;
and a control switch for operating the flow control device;
the control switch being responsive to a reduction in pressure within the waste storage tank below a predetermined minimum, indicating a requirement for re-filling the waste storage tank, to operate the flow control device to cause said flow;
the control switch, the reverse osmosis element and the flow control device being arranged such that, when the permeate storage tank is filled to less than capacity, the permeate is supplied to and stored in the permeate storage tank and, when the permeate supply tank is filled to capacity, no permeate passes through the membrane and all water received from the inlet is supplied to waste.

According to a third aspect of the invention there is provided a reverse osmosis water supply apparatus comprising:
an inlet for connection to a water source;
at least one reverse osmosis element including a membrane contained in a membrane housing, the element being arranged to receive water from the inlet and having a permeate outlet connected to a product side of the membrane and a waste outlet connected to a waste side of the membrane;
a pressurized permeate storage tank;
a valve operable by a user for tapping water on demand from the permeate storage tank;
a pressurized waste storage tank;
an outlet for connection from the waste storage tank to an end use location for use of the waste from the reverse osmosis element;
and a pump having a suction side connected to the waste outlet of the reverse osmosis element and a pressure outlet connected to the pressurized waste storage tank and arranged to draw water is away from the waste side of the membrane at a rate sufficient to ensure adequate flow on the waste side of the membrane to avoid an increase in contamination of the permeate.

This invention is based upon the understanding that the membrane passes a certain percentage of contaminants from the waste side to the product side so that an increase in contaminants on the waste side would result in an increase in contaminants on the product side even though the supply may be stable. Thus, in a situation where there is a back pressure from the pressurized waste storage tank, the flow rate from the waste side will reduce as the pressure approaches maximum thus leaving contaminants at the waste side of the membrane. This is avoided by the presence of the pump which pulls away the contaminants at a high flow rate regardless of the back pressure from the tank.

The booster pump is used exclusively to pressurize the RO wastewater to feed the toilet reservoirs and to maintain only the prescribed backpressure on the membrane elements. Backpressure on the membrane elements exerted by the wastewater holding tank and reduced membrane crossflow is eliminated by the suction of the pump and check valves being located at various critical points in the wastewater line, in addition to the waste pressure switch that shuts the system off when the waste tank is full.

According to a fourth aspect of the invention there is provided a reverse osmosis water supply apparatus comprising:
an inlet for connection to a water source;
at least one reverse osmosis element including a membrane contained in a membrane housing, the element being arranged to receive water from the inlet and having a permeate outlet connected to a product side of the membrane and a waste outlet connected to a waste side of the membrane;
a pressurized permeate storage tank;
a valve operable by a user for tapping water on demand from the permeate storage tank;
a pressurized waste storage tank;
an outlet for connection from the waste storage tank to an end use location for use of the waste from the reverse osmosis element;
a flow control device operable to cause flow of water from the source over the membrane for controlling the production from the membrane of the permeate and the waste and operable to halt flow;
and a bypass duct connected from the inlet directly to the outlet of the waste storage tank for supplying water from the source to the outlet of the waste storage tank, the bypass duct including a pressure regulator valve arranged to operate to allow passage of water from the source to the outlet of the waste storage tank only in the event that the pressure at the outlet of the waste storage tank drops below a predetermined minimum pressure.

### BRIEF DESCRIPTION OF THE DRAWINGS

One embodiment of the invention will now be described in conjunction with the accompanying drawings in which:

FIG. 1 is a schematic layout of one embodiment of the apparatus according to the present invention.

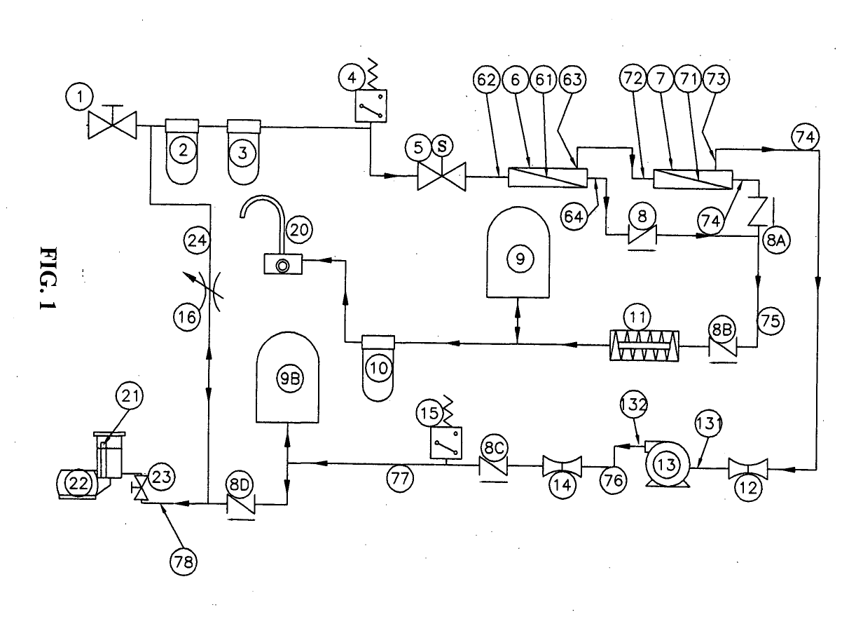

### DETAILED DESCRIPTION

The reverse osmosis apparatus as shown in the figure comprises a first reverse osmosis element 6 and second reverse osmosis element 7. Each of the elements includes a membrane 61, 71 so that water supplied at an inlet 62, 72 of the element passes over the membrane to provide product at a permeate outlet 64, 74 and waste water at an outlet 63, 73. The elements 6 and 7 are arranged in series so that the waste output from the waste side 63 of the membrane 61 is supplied as input 72 to the second element 7. The waste at the waste outlet 73 is supplied as waste water along a line 84 from the membrane system while the product water or permeate from the outlets 64 and 74 is supplied along a line 85. Back check valves 8 and 8A are provided in the line from the outlets 64 and 74 respectively to prevent back feed into the respective element 6,7. The third back check valve 8B is provided in the line 85 downstream of the junction of the two outputs.

The apparatus further comprises a product water or permeate storage tank 9 and a wastewater storage tank 9A. These tanks are of the pressurized bladder type so that they can operate between a filled condition and a partly filed condition by compressing a gas within the tank. Thus at the filled condition, a predetermined maximum pressure is reached which falls to a lower pressure as the water stored within the tank is expelled by the expansion of the pressurized gas. Normally such tanks are maintained between the filed and the partially filled condition by operation of a pressure valve which detects the predetermined maximum pressure and a lower predetermined minimum pressure.

The reverse osmosis elements 6 and 7 are supplied with water from a source which is fed to a valve 1 which can be operated to close off the system as required. Water from the source passes through a pre-sediment filter 2 followed by an activated carbon filter 3 for removal of contaminants which would otherwise damage the membrane element. A low pressure switch 4 detects low pressure at the source, indicating a failure of the supply, to shut off the system in the event that such a failure is detected. The switch 4 operates a solenoid valve 5 to close off the feed to the membrane elements thus closing off operation of the system.

The product water on the supply line 85 passes through the back check valve 8B to an optional treatment system 11 which can be of the UV type which is well known in the art. It will be appreciated that such UV treatment is used optionally in reverse osmosis systems and can be of use in the present system at the position located in the figure.

The product water is thus stored in the tank 9. The product water from the tank 9 or from the line 85 passes through a polishing filter 10 to the user operated valves or faucets indicated at 20 to be drawn off on demand.

The waste water on the line 84 passes through a flow restrictor 12 to a pump 13. The pump includes an inlet 131 and an outlet 132. From the outlet 132 the waste water passes along a line 76 to a further flow restrictor 14. A further back check valve 8C is located downstream of the flow restrictor 14 and upstream of a pressure switch 15. From the pressure switch 15, the waste water flows along a line 77 to the storage tank 9A. At the tank 9A is provided a further back check valve 8D. Thus water from the line 77 is either stored in the tank 9A or is supplied through the back check valve 8D to a valve 21 of a toilet tank 22. A further back check valve 23 is located in the line from the tank 9A to the valve 21. The valve 21 is a conventional tank filing valve which detects the level of water within the tank and closes off the supply when the level is filed.

The pressure switch 15 detects the pressure in the tank 9A so that the system is closed off when the tank is filed and is restarted when the pressure within the tank falls below a predetermined minimum set at the pressure switch 15. Thus the pressure switch 15 operates in the normal fill control mode of such bladder tanks but operates to control the filling of the waste tank 9A.

The switch 15 operates the pump 13 so that when the low pressure is reached, the pump 13 is started which draws water into the inlet 131 of the pump thus providing a predetermined negative pressure at the inlet 131. The flow restrictor 12 acts to restrict the flow of water along the line 84 from the waste outlet 73 thus providing a back pressure on the waste side of the membranes 61 and 71. The pump 13 however draws away the water from the waste side. It will be appreciated that, as the tank 9A approaches the filled condition, the pressure therein builds toward the predetermined maximum. Normally, in the absence of the pump 13, this would gradually reduce the flow rate along the line 84 thus reducing the flow rate drawing water from the waste side of the membranes. However the pump maintains a substantially constant flow rate so that it is independent of the pressure within the tank 9A. Thus the pressure at the membranes and the flow rate at the membranes is determined by the flow rate of the pump rather than the pressure at the tank 9A and this can be adjusted by setting the restriction 12 to provide the required back pressure and the required flow rate to maintain the membranes with the required contaminants on the waste side to provide optimum performance.

It will be further appreciated that, in accordance with known operating conditions of such membrane systems, the presence of increased contaminants on the waste side of the membrane would otherwise increase the contaminants passing through the membrane since the membrane acts to pass a proportion of contaminants, which proportion is substantially constant. Thus the action of the pump to maintain the contaminants on the waste side at a low level, by drawing away the contaminants in a predetermined flow rate, avoids the reduction in efficiency of operation of the membranes and thus an increase in contaminants in the product water.

The system operates by detecting when the tank 9A is filled or requires further filling. In the event that the tank 9A requires additional waste water while the tank 9 is completely filled, the membranes operate to generate no permeate so that they pass all of the inlet water to the waste side. In this way the system is operated by detecting the quantity of waste produced rather than the quantity of product water produced. The system will normally be set up by selection of the components so that the amount of product generated in proportion to the amount of waste generated is suitable for the average household. Thus typically the average household may utilise two (2) gallons per day of product water and twelve (12) gallons per day of waste water in one or more toilets. If the system is balanced so as to tend to produce slightly more product water than is required, the system can be run based upon the requirement for waste water with the expectation that the quantity of product water will always be sufficient.

In the event that excess usage of product water occurs, the householder will appreciate that additional product water can be rapidly generated simply by flushing the toilet.

In the event that the system fails so that insufficient waste water is produced allowing the tank 9A to become emptied below a predetermined pressure, water is automatically supplied to the outlet 78 for supply to the toilet 22 by a bypass duct 24 connected between the inlet at the valve 1 and the outlet 78. The bypass duct 24 includes a pressure regulator valve 16 which allows passage of water from the inlet at the valve 1 to the outlet 78 only when the pressure differential between the inlet and the outlet exceeds a predetermined value. Thus if the pressure at the outlet 78 falls due to a reduction in pressure in the tank 9A due to a temporary high demand or, very occasionally, due to a failure of the system, and this fall reaches the point where the pressure difference between the inlet and the outlet 78 is greater than a predetermined pressure drop, then water is bypassed through the duct 24 past the valve 16 to continue to fill the tank via the valve 21. The flow restrictor 23, which may be provided by natural flow restrictions in the valve 21 rather than as a specific separate element, maintains a back pressure at the outlet 78 so that the valve 16 is only actuated when the pressure in tank 9A falls below the predetermined minimum set by the valve 16 indicating that the system has failed. Thus at all times, even in the event of failure, water is available for flushing the toilet although though of course no product water will be available due to the failure of the system.

The most common use of the bypass will be when a temporary heavy demand on toilet refill water exceeds the capacity of the system to generate wastewater, even though the system is operating normally and will become rebalanced when refill demand normalizes. It can also be used in the rare case of a system failure.

The system disclosed uses a conventional RO technology and components combined with several new approaches in recycling the waste stream and operating the overall system. The key processes employed are:

Incoming feed water is filtered with a 5-micron sediment cartridge and a 5-micron granular activated carbon (or 5 micron carbon briquette) cartridge. A low-pressure switch is connected to the feed water line and will shut down the RO unit should an insufficient line pressure be detected.

Two membrane elements are used, the waste of the first becoming the feed of the second. The first element is rated at 100 USGPM, the second at 75 USGPM. This increases the recovery rate of the overall system and lowers the waste to product ratio to approximately 1:3. This could be referred to as a “double pass” or “cascade” arrangement. Both are pressurized at the municipal line pressure without the aid of a booster pump.

The waste stream from the second membrane element is fed into the suction of a booster pump that pumps the waste stream to a 14-gallon bladder-style holding tank. When the wastewater holding tank is filled a pressure switch (set at 40 psi) shuts the booster pump off and closes a solenoid valve connected to the feed water line into the RO unit.

A flow restrictor is installed between the pump suction and the waste outlet of the second membrane housing, in order to provide backpressure on the membrane elements and maintain a constant pressure sufficient to allow the element to operate.

Permeate streams from both membranes are blended and connected to a 14-gallon bladder-style product water holding tank. There is no mechanism installed on the unit to shut it off if the product tank is full. The system will merely continue to operate and shut down when the waste tank is full. Hence, the system is operated by the fill status of the waste tank.

The waste tank is connected to one or more household toilets and provides the water to fill the toilet reservoir(s) when the toilet valve(s) opens to be refilled. Each toilet water connection is fitted with a diverter valve that is used to tee in the waste stream and shut off the normal water flow to the toilet from the household plumbing system. The diverter valve can also be turned on to allow the toilet to be filled with the normal household plumbing system at the option of the user.

Should the demand for toilet refill water at any time exceed the water available in the wastewater tank, the entire RO system is automatically bypassed by a cold water line that is controlled by a pressure regulator set at 20 psi. At any wastewater pressure above 20 psi this bypass will not operate due to the greater pressure exerted by the wastewater line.

A check valve is installed in the wastewater tube to the toilet to keep the refill bypass from refilling the wastewater tank.

Product water is drawn from the product tank by a toggle faucet typically located at the user's kitchen sink. When the faucet is opened water from the product tank flows through a carbon briquette cartridge to polish the water before being delivered to the user.

As noted, the wastewater from the RO unit is used exclusively for the operation of toilets in the residence. The RO wastewater used in the operation of the toilets is instead of fresh water from the plumbing system that would otherwise be used; hence operating the RO system has not increased net consumption of household water.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A reverse osmosis water supply apparatus comprising:
an inlet for connection to a water source;
at least one reverse osmosis element including a membrane contained in a membrane housing, the element being arranged to receive water from the inlet and having a permeate outlet connected to a product side of the membrane and a waste outlet connected to a waste side of the membrane;
a pressurized permeate storage tank connected to the permeate outlet;
a valve operable by a user for tapping water on demand from the permeate storage tank;
a pressurized waste storage tank connected to the waste outlet;
a flow control device operable to cause flow of water from the source over the membrane for controlling the production from the membrane of the permeate and the waste and operable to halt flow;
a toilet tank for supplying flush water to a toilet;
a filling valve operable to fill the toilet tank to a required level in response to use of the flush water;
a connection from the waste storage tank to the filling valve of the toilet tank for filling the toilet tank with waste from the reverse osmosis element.

2. The apparatus according to claim 1 wherein there is provided a control switch for operating the flow control device, the control switch being responsive to a reduction in pressure within the waste storage tank below a predetermined minimum, indicating a requirement for re-filling the waste storage tank, to operate the flow control device to cause said flow.

3. The apparatus according to claim 2 wherein the control switch, the reverse osmosis element and the flow control device are arranged such that, when the permeate storage tank is filled to less than capacity, the permeate is supplied to and stored in the permeate storage tank and, when the permeate supply tank is filled to capacity, no permeate passes through the membrane and all water received from the inlet is supplied to waste.

4. The apparatus according to claim 1 wherein the flow control device comprises a pump having a suction side connected to the waste outlet of the reverse osmosis element and a pressure outlet connected to the pressurized waste storage tank and arranged to draw water is away from the waste side of the membrane at a rate sufficient to ensure adequate flow on the waste side of the membrane to avoid an increase in contamination of the permeate.

5. The apparatus according to claim 4 wherein the pump is arranged such that the rate of flow on the waste side is substantially independent of the pressure in the waste storage tank.

6. The apparatus according to claim 4 wherein there is provided a flow restrictor between the inlet of the pump and the waste outlet of the element so as to provide a back pressure against the waste side of the membrane.

7. The apparatus according to claim 1 wherein there is provided a bypass duct connected from the inlet directly to the outlet of the waste storage tank for supplying water from the source to the outlet of the waste storage tank, the bypass duct including a pressure regulator valve arranged to operate to allow passage of water from the source to the outlet of the waste storage tank only in the event that the pressure at the outlet of the waste storage tank drops below a predetermined minimum pressure.

8. The apparatus according to claim 7 wherein there is provided a back check valve between the duct and the outlet of the waste storage tank to prevent filling of the waste storage tank from the source.

9. The apparatus according to claim 1 wherein the at least one reverse osmosis element comprises a first and a second reverse osmosis element each including a membrane contained in a membrane housing, the element being arranged to receive water from the inlet and having a permeate outlet connected to a product side of the membrane and a waste outlet connected to a waste side of the membrane and wherein the permeate from the product side of the first is supplied as input to the second.

10. A reverse osmosis water supply apparatus comprising:
an inlet for connection to a water source;
at least one reverse osmosis element including a membrane contained in a membrane housing, the element being arranged to receive water from the inlet and having a permeate outlet connected to a product side of the membrane and a waste outlet connected to a waste side of the membrane;
a pressurized permeate storage tank;
a valve operable by a user for tapping water on demand from the permeate storage tank;
a pressurized waste storage tank;
an outlet for connection from the waste storage tank to an end use location for use of the waste from the reverse osmosis element;
a flow control device operable to cause flow of water from the source over the membrane for controlling the production from the membrane of the permeate and the waste and operable to halt flow;
and a control switch for operating the flow control device;
the control switch being responsive to a reduction in pressure within the waste storage tank below a predetermined minimum, indicating a requirement for re-filling the waste storage tank, to operate the flow control device to cause said flow;
the control switch, the reverse osmosis element and the flow control device being arranged such that, when the permeate storage tank is filled to less than capacity, the permeate is supplied to and stored in the permeate storage tank and, when the permeate supply tank is filled to capacity, no permeate passes through the membrane and all water received from the inlet is supplied to waste.

11. The apparatus according to claim 10 wherein the flow control device comprises a pump having a suction side connected to the waste outlet of the reverse osmosis element and a pressure outlet connected to the pressurized waste storage tank and arranged to draw water is away from the waste side of the membrane at a rate sufficient to ensure adequate flow on the waste side of the membrane to avoid an increase in contamination of the permeate.

12. The apparatus according to claim 11 wherein the pump is arranged such that the rate of flow on the waste side is substantially independent of the pressure in the waste storage tank.

13. The apparatus according to claim 11 wherein there is provided a flow restrictor between the inlet of the pump and the waste outlet of the element so as to provide a back pressure against the waste side of the membrane.

14. The apparatus according to claim 10 wherein the at least one reverse osmosis element comprises a first and a second reverse osmosis element each including a membrane contained in a membrane housing, the element being arranged to receive water from the inlet and having a permeate outlet connected to a product side of the membrane and a waste outlet connected to a waste side of the membrane and wherein the permeate from the product side of the first is supplied as input to the second.

15. A reverse osmosis water supply apparatus comprising:
an inlet for connection to a water source;
at least one reverse osmosis element including a membrane contained in a membrane housing, the element being arranged to receive water from the inlet and having a permeate outlet connected to a product side of the membrane and a waste outlet connected to a waste side of the membrane;
a pressurized permeate storage tank;
a valve operable by a user for tapping water on demand from the permeate storage tank;
a pressurized waste storage tank;
an outlet for connection from the waste storage tank to an end use location for use of the waste from the reverse osmosis element;
and a pump having a suction side connected to the waste outlet of the reverse osmosis element and a pressure outlet connected to the pressurized waste storage tank and arranged to draw water is away from the waste side of the membrane at a rate sufficient to ensure adequate flow on the waste side of the membrane to avoid an increase in contamination of the permeate.

16. The apparatus according to claim 15 wherein the pump is arranged such that the rate of flow on the waste side of the membrane is substantially independent of the pressure in the waste storage tank.

17. The apparatus according to claim 15 wherein there is provided a flow restrictor between the inlet of the pump and the waste outlet of the element so as to provide a back pressure against the waste side of the membrane

18. The apparatus according to claim 15 wherein the at least one reverse osmosis element comprises a first and a second reverse osmosis element each including a membrane contained in a membrane housing, the element being arranged to receive water from the inlet and having a permeate outlet connected to a product side of the membrane and a waste outlet connected to a waste side of the membrane and wherein the permeate from the product side of the first is supplied as input to the second.

19. A reverse osmosis water supply apparatus comprising:
an inlet for connection to a water source;
at least one reverse osmosis element including a membrane contained in a membrane housing, the element being arranged to receive water from the inlet and having a permeate outlet connected to a product side of the membrane and a waste outlet connected to a waste side of the membrane;
a pressurized permeate storage tank;
a valve operable by a user for tapping water on demand from the permeate storage tank;
a pressurized waste storage tank;
an outlet for connection from the waste storage tank to an end use location for use of the waste from the reverse osmosis element;
a flow control device operable to cause flow of water from the source over the membrane for controlling the production from the membrane of the permeate and the waste and operable to halt flow;
and a bypass duct connected from the inlet directly to the outlet of the waste storage tank for supplying water from the source to the outlet of the waste storage tank, the bypass duct including a pressure regulator valve arranged to operate to allow passage of water from the source to the outlet of the waste storage tank only in the event that the pressure at the outlet of the waste storage tank drops below a predetermined minimum pressure.

20. The apparatus according to claim 19 wherein there is provided a back check valve between the duct and the outlet of the waste storage tank to prevent filling of the waste storage tank from the source.

21. The apparatus according to claim 19 wherein the at least one reverse osmosis element comprises a first and a second reverse osmosis element each including a membrane contained in a membrane housing, the element being arranged to receive water from the inlet and having a permeate outlet connected to a product side of the membrane and a waste outlet connected to a waste side of the membrane and wherein the permeate from the product side of the first is supplied as input to the second.
